(19) United States
(12) Patent Application Publication
(10) Pub. No.: US 2026/0312448 A1
(43) Pub. Date: Oct. 8, 2026

(54) ROTOR, MOTOR, AND ELECTRONIC DEVICE

(71) Applicant: MINEBEA MITSUMI Inc., CityNagano (JP)

(72) Inventors: Junichi MIYAKI, Kitasaku-gun (JP); Bingjie SHI, Kitasaku-gun (JP); Takashi YAMAMOTO, Kitasaku-gun (JP); Takuma SAITO, Kitasaku-gun (JP)

(21) Appl. No.: 19/485,023

(22) PCT Filed: May 26, 2023
(86) PCT No.: PCT/JP2023/019794

§ 371 Date: Nov. 17, 2025

(51) Int. Cl. H02K 1/276; H02K 1/28; H02K 7/116; H02K 21/16

(52) U.S. Cl. CPC H02K 1/2773; H02K 1/28; H02K 7/1166; H02K 21/16

(57) ABSTRACT

A rotor includes a magnetic body including two magnetic pole parts, an annular part, and a protruding part protruding from the annular part, and a magnet located between the two magnetic pole parts in a circumferential direction. The magnetic body includes a plurality of magnetic members stacked in an axial direction. In a radial direction, the magnet is in contact with the protruding part. In a rotation axis direction, parts of the plurality of magnetic members forming the protruding part are engaged with each other directly or via another member.

### TECHNICAL FIELD

The present invention relates to a rotor, a motor, and an electronic device.

### BACKGROUND ART

So-called interior permanent magnet (IPM) rotors, used in inner rotor type motors, are known. In the interior permanent magnet motors, plate-shaped magnets magnetized in front and back directions of the rotor are disposed in the shape of spokes in a radial direction such that two adjacent plate-shaped magnets repel each other.

### CITATION LIST

### Patent Literature

Patent Document 1: JP 2013-529054 T
Patent Document 2: JP 2021-158795 A

### SUMMARY OF INVENTION

### Technical Problem

When an IPM rotor is used in a high ambient temperature environment, demagnetization due to high heat is likely to occur on the outer surface side. Furthermore, increasing a contact area between a magnet and a magnetic body may increase leakage magnetic flux toward the inner surface side. Such leakage magnetic flux and demagnetization are obstacles to improvement of motor characteristics.

According to one aspect, an object of the present invention is to provide a rotor, a motor, and an electronic device that can improve motor characteristics.

### Solution to Problem

In one aspect, a rotor includes: a magnetic body including two magnetic pole parts, an annular part, and a protruding part protruding from the annular part; and a magnet located between the two magnetic pole parts in a circumferential direction. The magnetic body includes a plurality of magnetic members stacked in an axial direction. In a radial direction, the magnet is in contact with the protruding part. In a rotation axis direction, parts of the plurality of magnetic members forming the protruding part are engaged with each other directly or via another member.

According to one aspect, motor characteristics can be improved.

### BRIEF DESCRIPTION OF DRAWINGS

FIG. 1 is a perspective view illustrating an example of an electronic device according to an embodiment.

FIG. 2 is an exploded perspective view illustrating an example of a motor according to the embodiment.

FIG. 3 is a perspective view illustrating an example of a rotor core according to the embodiment.

FIG. 4 is a cross-sectional view illustrating an example of a rotor with a shaft inserted in the rotor according to the embodiment.

FIG. 5 is an enlarged cross-sectional view illustrating an example of the rotor according to the embodiment.

FIG. 6 is a cross-sectional perspective view illustrating an example of the rotor with a shaft inserted in the rotor according to the embodiment.

FIG. 7 is an enlarged cross-sectional view illustrating an example of a magnetic member according to the embodiment.

FIG. 8 is a cross-sectional view illustrating an example of an engaged magnetic member according to the embodiment.

FIG. 9 is a view illustrating an example of insertion of an engaging member into a rotor according to a modified example.

FIG. 10 is an enlarged cross-sectional view illustrating an example of a magnetic member according to another modified example.

### DESCRIPTION OF EMBODIMENTS

Hereinafter, embodiments of a rotor, a motor, and an electronic device disclosed in the present application will be described in detail with reference to the drawings. Note that the dimensional relationship between elements and the ratio of each element in the drawings may differ from reality. Some of the parts may different in dimensional relationship and scale in different drawings. In each of the drawings, a coordinate system including at least any one of an axial direction (rotation axis direction of a motor 1 to be described later), a radial direction, or a circumferential direction of the motor 1 may be illustrated for the purpose of facilitating explanation. In addition, the rotation axis direction of the motor 1 may be simply referred to as an “axial direction” below.

### First Embodiment

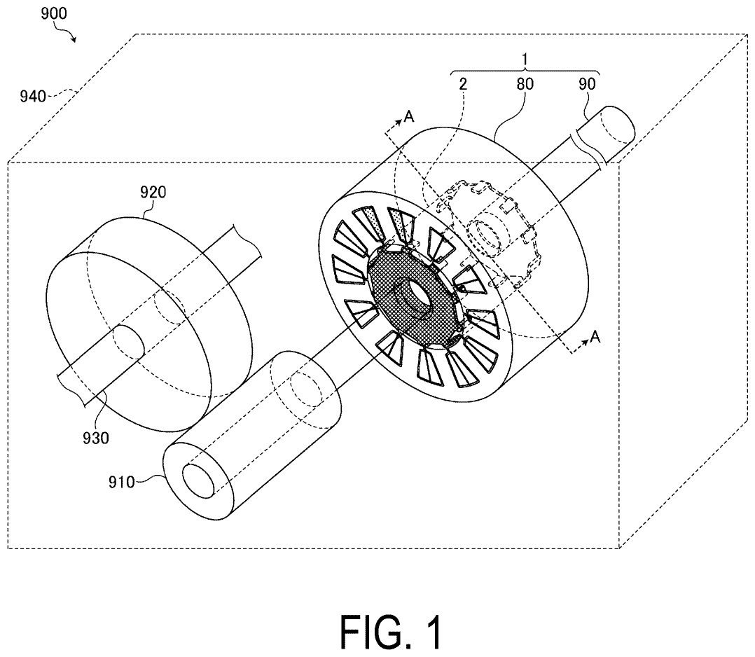

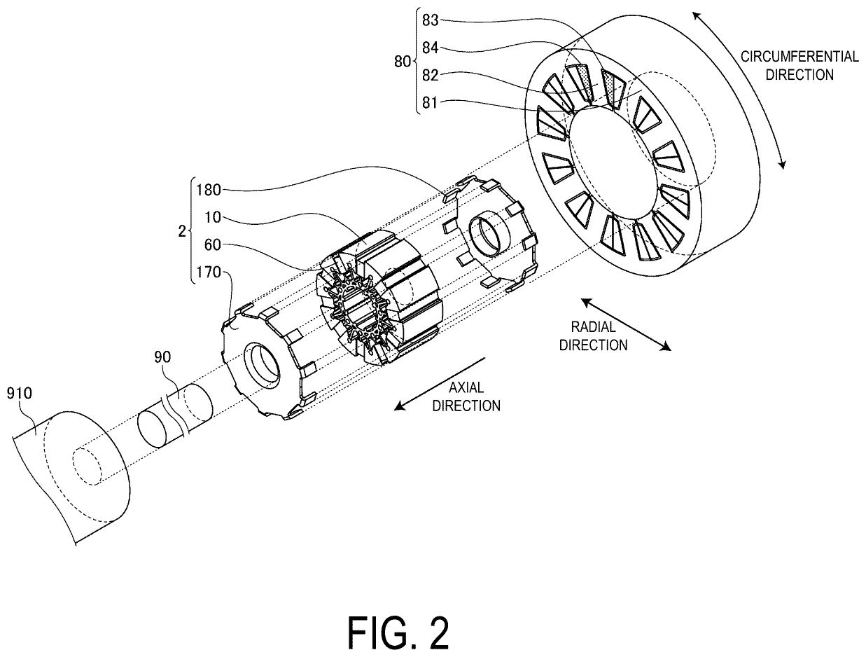

The motor 1 according to the embodiment is accommodated in, for example, an electronic device 900 as illustrated in FIG. 1. FIG. 1 is a perspective view illustrating an example of the electronic device according to the embodiment. FIG. 2 is an exploded perspective view illustrating an example of the motor according to the embodiment. As illustrated in FIGS. 1 and 2, the motor 1 according to the embodiment includes a rotor 2, a shaft 90, and a stator 80. The motor 1 described in the embodiment is, for example, an inner rotor type brushless motor. In the inner rotor type brushless motor, the stator 80 is located on an outer circumference side of the rotor 2 in the radial direction.

The electronic device 900 is a device or a mobile object having a high ambient temperature inside, such as a hybrid vehicle. As illustrated in FIG. 1, the electronic device 900 according to the embodiment includes the motor 1 and a housing 940 that accommodates the motor 1.

The electronic device 900 may also include the motor 1 and one or more gears 910 and 920. The gear 910 is, for example, a worm gear, and rotates in conjunction with a shaft 90 of the motor 1. The gear 920 is, for example, a helical gear that meshes with the worm gear 910 and rotates in conjunction with an output shaft 930. With this configuration, the driving force of the shaft 90 of the motor 1 is transmitted to the output shaft 930 of the output gear 920.

As illustrated in FIG. 2, the stator 80 includes a yoke 81, teeth 82, coils 83, and insulators 84. The yoke 81 is an annular member formed on an outer circumference side of the stator 80. The teeth 82 protrude radially inward from the yoke 81. The yoke 81 and the teeth 82 are formed by, for example, punching a flat plate-shaped member made of a magnetic material, such as a magnetic steel plate, into the shape illustrated in FIG. 2, and stacking a plurality of the punched members in the axial direction. The coils 83 are wound around the teeth 82 via the insulators 84, for example.

As illustrated in FIGS. 1 and 2, the rotor 2 is rotatably inserted radially inside the stator 80. The rotor 2 includes a magnetic body 10 and a plurality of magnets 60.

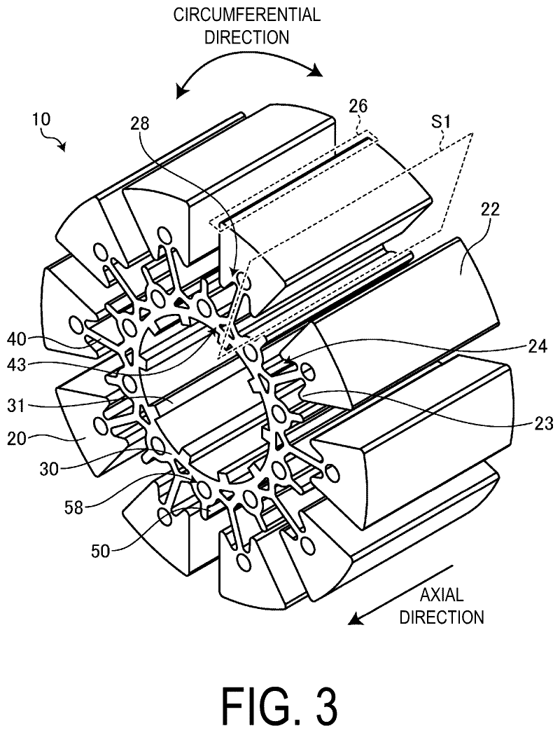

As illustrated in FIG. 3, the magnetic body 10 includes two magnetic pole parts 20, an annular part 30, and a first protruding part 50 protruding from the annular part 30. FIG. 3 is a perspective view illustrating an example of a rotor core according to the embodiment. The first protruding part 50 is an example of a protruding part.

The annular part 30 is disposed radially inside the magnetic body 10. The annular part 30 forms an inner circumferential part of the magnetic body 10. The magnetic pole part 20 is disposed radially outside the magnetic body 10. The magnetic pole part 20 forms an outer circumferential part of the magnetic body 10. The magnetic body 10 according to the embodiment includes two or more magnetic pole parts 20. The plurality of magnetic pole parts 20 are formed aligned in the circumferential direction.

Each magnetic pole part 20 includes an end part (hereinafter referred to as a tip part) 23 that protrudes radially inward, and an outer circumferential surface 22 that extends in the circumferential direction. The tip parts 23 form a part of an inner surface of the magnetic pole part 20, and between the two tip parts 23, as illustrated in FIG. 3, a recessed part 24 is formed. The recessed part 24 forms another part of the inner surface of the magnetic pole part 20. The outer circumferential surface 22 of the magnetic pole part 20 forms the outer circumferential part of the magnetic body 10. Further, an end part 26 in the circumferential direction of an outer circumferential surface 21 of the magnetic pole part 20 has a continuous shape in the circumferential direction or the radial direction, and forms a curved surface.

The magnetic body 10 also includes a connection part 40 that connects the magnetic pole part 20 and the annular part 30. As illustrated in FIG. 3, the connection part 40 is formed between the magnetic pole part 20 and the annular part 30 in the radial direction. The connection part 40 is formed between the recessed parts 24 illustrated in FIG. 3 in the circumferential direction.

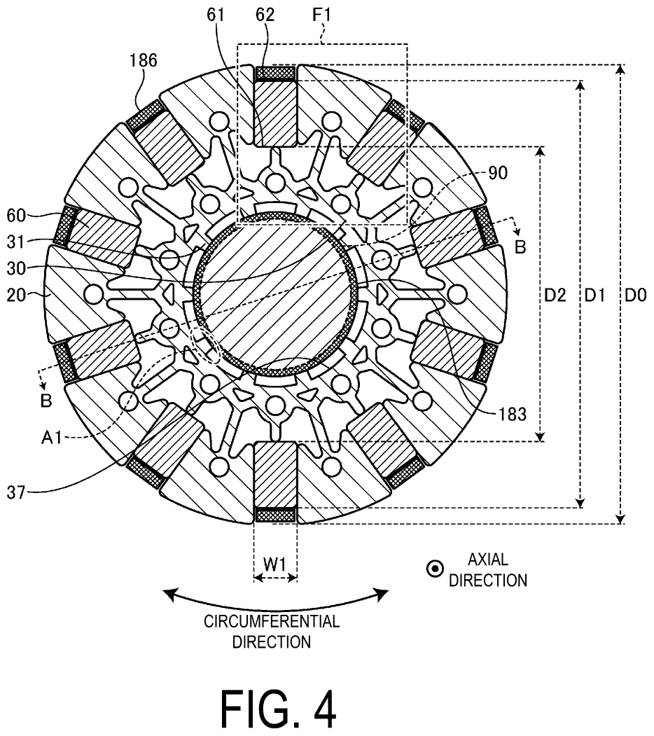

The magnet 60 according to the embodiment is, for example, a plate-shaped magnet extending in an axial direction. As illustrated in FIG. 4, the magnet 60 is located between the two magnetic pole parts 20 in the circumferential direction. FIG. 4 is a cross-sectional view illustrating an example of a rotor with a shaft inserted in the rotor according to the embodiment. FIG. 4 illustrates a cross section, taken along a line AA, of the rotor 2 with the shaft 90 illustrated in FIG. 1 inserted in the rotor 2. As illustrated in FIG. 4, the rotor 2 according to the embodiment is a spoke-type IPM rotor, and a plurality of magnets 60 are disposed radially. Further, an outer diameter D0 of the rotor 2 according to the embodiment illustrated in FIG. 4 is, for example, 24.5 mm.

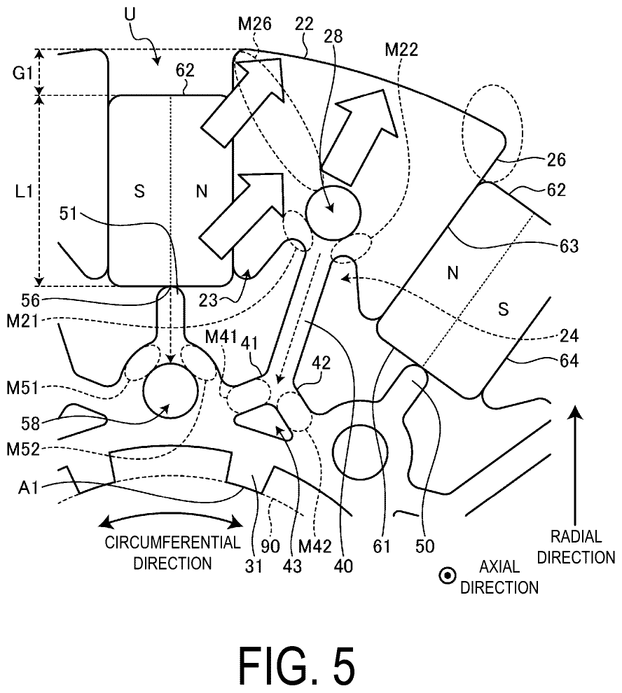

As illustrated in FIG. 5, the magnet 60 includes an inner end surface (inner surface) 61 in the radial direction, an outer end surface (outer surface) 62 in the radial direction, and side surfaces 63 and 64 in the circumferential direction. FIG. 5 is an enlarged cross-sectional view illustrating an example of the rotor according to the embodiment. FIG. 5 is an enlarged view of a part indicated by a frame F1 in FIG. 4. In the embodiment, a circumferential width W1 of the magnet 60 illustrated in FIG. 4 is, for example, the outer diameter D0×2.22/24.5, and a magnet length (radial length) W1 of the magnet 60 illustrated in FIG. 5 is, for example, the outer diameter D0×3.5/24.5.

In the present embodiment, two magnets 60 adjacent to each other in the circumferential direction via the magnetic pole part 20 are disposed such that the same poles oppose each other. For example, as illustrated in FIG. 5, two magnets 60 adjacent to each other in the circumferential direction are disposed such that north poles oppose each other.

In the rotor 2 illustrated in FIG. 4, the magnets 60 disposed at the magnetic body 10 may move radially outside the magnetic body 10 or in a positive or negative axial direction due to a repulsive force with respect to other adjacent magnets 60 in the circumferential direction or a centrifugal force generated by the rotation of the rotor 2.

Therefore, the rotor 2 according to the embodiment further includes covers 170 and 180 as illustrated in FIG. 2. As illustrated in FIG. 2, the cover 170 is attached to the magnetic body 10 from the positive side in the axial direction, and the cover 180 is attached to the magnetic body 10 from the negative side in the axial direction.

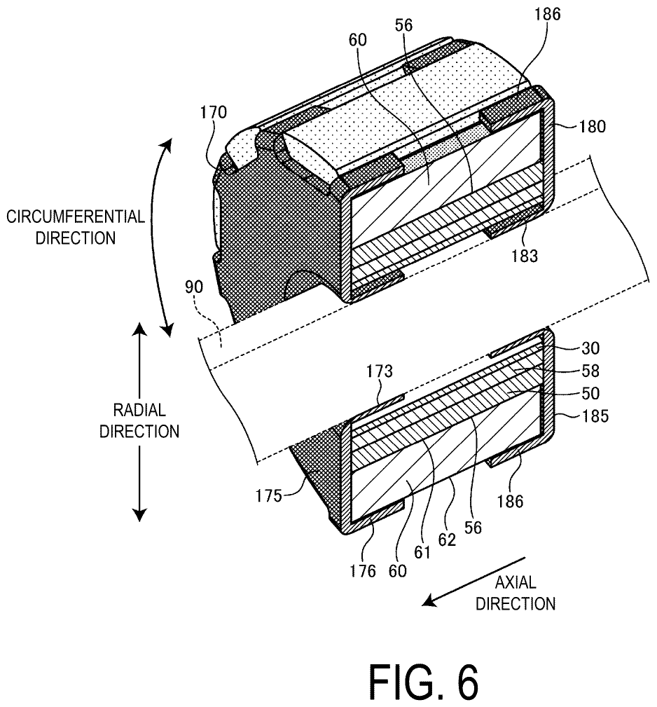

As illustrated in FIG. 6, the cover 170 includes a plurality of outer circumferential parts 176, a flat part 175 extending in the radial direction, and an inner circumferential part 173. FIG. 6 is a cross-sectional perspective view illustrating an example of the rotor with a shaft inserted in the rotor according to the embodiment. FIG. 6 illustrates a cross section taken along a line BB in FIG. 4. In addition, the covers 170 and 180 according to the embodiment have the same shape, and the matters described below regarding the cover 170 also apply to the cover 180 unless otherwise specified. Similarly, matters described regarding the cover 180 also apply to cover 170 unless otherwise specified.

In the present embodiment, the cover 170 is made of a non-magnetic material, such as brass. Furthermore, the cover 170 may be formed by bending a material having lower magnetic properties than the magnetic steel plate that constitutes the magnetic body 10, such as austenitic stainless steel.

As illustrated in FIG. 6, each outer circumferential part 176 protrudes from the flat part 175 toward the negative side in the axial direction, and each outer circumferential part 186 protrudes from the flat part 185 toward the positive side in the axial direction. The plurality of outer circumferential parts 176 and 186 are formed, for example, aligned at equal intervals in the circumferential direction. More specifically, the outer circumferential part 186 is formed at a position in contact with the outer end surface 62 of the magnet 60 in the radial direction, as illustrated in FIGS. 4 and 6, and a plurality of outer circumferential parts 186 are formed, and the number of the outer circumferential parts 186 is the same as the number of magnets 60.

Similarly to the outer circumferential part 176, the inner circumferential part 173 protrudes from the flat part 175 toward the negative side in the axial direction, and the inner circumferential part 183 protrudes from the flat part 185 toward the positive side in the axial direction. The outer diameter (size) of the inner circumferential parts 173 and 183 is, for example, approximately the same as or slightly larger than the inner diameter (size) of the second protruding part 31 formed at the annular part 30 of the magnetic body 10. The inner diameter of the inner circumferential parts 173 and 183 is, for example, approximately the same as or slightly smaller than the outer diameter (size) of the shaft 90.

In this configuration, the covers 170 and 180 are, for example, inserted and press-fitted into the second protruding part 31 of the magnetic body 10 in the radial direction. Thereafter, the shaft 90 is inserted and press-fitted into the inner circumferential parts 173 and 183. That is, in the embodiment, the covers 170 and 180, and the magnetic body 10 and the shaft 90 form a double press-fit structure. At this time, in the cross-sectional view illustrated in FIG. 4, the outer circumferential part 186 and the inner circumferential part 183 of the cover 180 are visually recognized on the negative side in the axial direction. With this configuration, since a contact area A1 between the covers 170 and 180 and the second protruding part 31 of the magnetic body 10 illustrated in FIG. 4 is reduced, the stress applied to the magnetic body 10 from the covers 170 and 180 is reduced.

Further, the flat part 175 of the cover 170 opposes (or contacts) the magnet 60 from the positive side in the axial direction, and the flat part 185 of the cover 180 opposes (or contacts) the magnet 60 from the negative side in the axial direction. Furthermore, a part, on the positive side in the axial direction, of the outer end surface 62 of the magnet 60 in the radial direction opposes (or contacts) the outer circumferential part 176 of the cover 170 in the radial direction, and another part on the negative side opposes (or contacts) the outer circumferential part 186 of the cover 180 in the radial direction. With this configuration, the movement of the magnet 60 in the axial direction or the radial direction is suppressed.

When the outer diameter D0 is small as in the rotor 2 according to the embodiment, it is difficult to form a structure in the covers 170 and 180 that holds the magnet 60 from the inside in the radial direction. For example, as illustrated in FIG. 6, the end surface 61 inside the magnet 60 is located outside the inner circumferential part 173 of the cover 170 and the inner circumferential part 183 of the cover 180, and is located at a position away from the inner circumferential part 173 of the cover 170 and the inner circumferential part 183 of the cover 180. Therefore, in the rotor 2 according to the embodiment, the first protruding part 50 supports the inner surface 61 of the magnet 60 from the inside in the radial direction.

As illustrated in FIG. 5, the first protruding part 50 of the magnetic body 10 protrudes, from the annular part 30, outward in the radial direction (on the magnet 60 side). At this time, the magnet 60 is in contact with the protruding part 50 in the radial direction. Specifically, a part (contact part 56) of the inner end surface 61 of the magnet 60 is in contact with the first protruding part 50 in the radial direction.

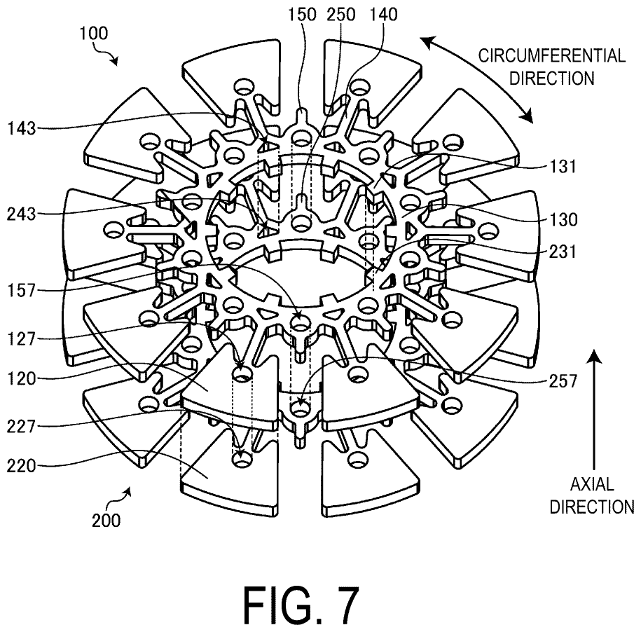

As illustrated in FIG. 7, in the embodiment, the magnetic body 10 includes a plurality of magnetic members 100 and 200 stacked in the axial direction. FIG. 7 is an enlarged cross-sectional view illustrating an example of the magnetic member according to the embodiment. As illustrated in FIG. 7, the magnetic member 100 is stacked at another magnetic member 200 having the same shape as the magnetic member 100 from the positive side in the axial direction. Although two magnetic members 100 and 200 are illustrated in FIG. 7, the number of magnetic members to be stacked is not limited to two. Hereinafter, the description of the magnetic member 100 also applies to the magnetic member 200 and other magnetic members.

As illustrated in FIG. 7, the magnetic member 100 includes a first part (hereinafter referred to as a magnetic pole part constituent part) 120 constituting the magnetic pole part, a protruding part 150, a second part (hereinafter referred to as a connection part constituent part) 140 constituting the connection part, and a third part (hereinafter referred to as a annular part constituent part) 130 constituting the annular part. The protruding part 150 is an example of a part of the plurality of magnetic members constituting the protruding part.

In the embodiment, the magnetic pole part constituent part 120 of the magnetic member 100 is engaged with a magnetic pole part constituent part 220 of the other magnetic member 200. For example, second engaging parts 127 and 227 are formed in parts of the magnetic members 100 and 200 constituting the magnetic pole part 20. In this case, the second engaging part 127 formed on the magnetic pole part constituent part 120 is crimped to the second engaging part 227 formed at the magnetic pole part constituent part 220, thus the magnetic pole part constituent parts 120 and 220 are engaged with each other. That is, a part of the plurality of magnetic members constituting the magnetic pole part includes the second engaging parts 127 and 227. For example, in the radial direction, the second engaging parts 127 and 227 are located on the connection part 40 side. As will be described later, the magnetic pole part constituent parts 120 and 220 may be engaged by other members. That is, a part of the plurality of magnetic members constituting the magnetic pole part is engaged with a part of the magnetic pole part on the connection part side in a rotation axis direction, directly or via another member.

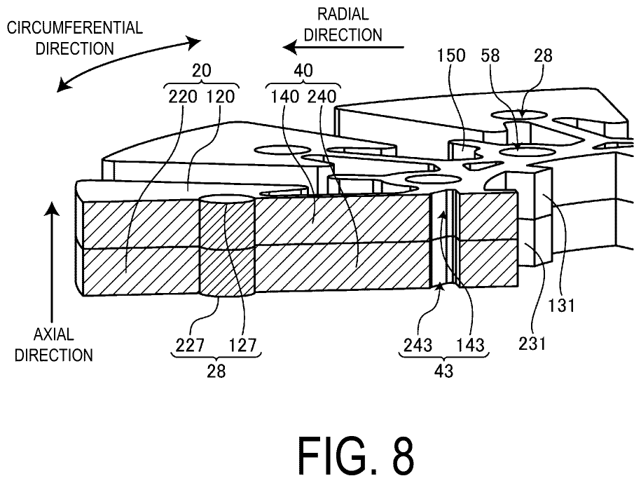

As illustrated in FIG. 8, the second engaging part 127 of the magnetic member 100 is crimped to the second engaging part 227 of the other magnetic member 200, thus a second coupling part 28 illustrated in FIG. 4 is formed at the magnetic pole part 20 of the magnetic body 10. FIG. 8 is a cross-sectional view illustrating an example of an engaged magnetic member according to the embodiment. The second coupling part 28 is an example of a plurality of second engaging parts stacked in the rotation axis direction.

The stress generated by the second engaging parts 127 and 227 crimped together remains in the second coupling part 28. Accordingly, the magnetic permeability in the second coupling part 28 is lower than a magnetic permeability in other parts of the magnetic pole part 20. In this case, the second coupling part 28 forms a flux barrier in the magnetic body 10.

In addition, in the embodiment, the protruding part 150 of the magnetic member 100 is engaged with a protruding part 250 of the other magnetic member 200. For example, a first engaging part 157 formed at the protruding part 150 illustrated in FIG. 7 is crimped to a first engaging part 257 formed at the protruding part 250, thus the protruding parts 150 and 250 are engaged with each other. That is, each of the parts of the plurality of magnetic members constituting the protruding part includes a first engaging part. As will be described later, the protruding parts 150 and 250 may be engaged by other members. That is, in the rotation axis direction, the protruding parts 150 and 250 are engaged with each other directly or via another member. Furthermore, the connection part constituent part 140 is connected to the first engaging part 157 of the magnetic member. The connection part constituent part 140 is an example of a part of the magnetic member constituting the connection part.

The first engaging part 157 of the magnetic member 100 illustrated in FIG. 7 is crimped to the first engaging part 257 of the other magnetic member 200, thus a first coupling part 58 illustrated in FIG. 5 is formed at the first protruding part 50 of the magnetic body 10. The first coupling part 58 is an example of a first engaging part stacked in the rotation axis direction.

The first coupling part 58 has a lower magnetic permeability than the other parts of the first protruding part 50 due to the stress remaining when the first engaging parts 157 and 257 are crimped together. In this case, the first coupling part 58 forms a flux barrier in the magnetic body 10.

According to this configuration, as illustrated in FIG. 5, magnetic paths M51 and M52 extending from the first protruding part 50 toward the annular part 30 are narrowed by the first coupling part 58. Accordingly, magnetic saturation is likely to occur in the magnetic paths M51 and M52, and thus, leakage of magnetic flux from the inner end surface 61 of the magnet 60 to the inside in the radial direction through the magnetic path M51 or M52 is suppressed.

Furthermore, as indicated by the arrow in FIG. 5, magnetic flux flows from the side surfaces 63 and 64 in the circumferential direction of the magnet 60 toward the outer circumferential surface 22 of the magnetic pole part 20 via the tip part 23 of the magnetic pole part 20. At this time, since the end part 26 of the outer circumferential surface 21 of the magnetic pole part 20 has a shape that spreads out (or a larger area) toward the magnets 60 that are adjacent to each other via the magnetic pole part 20, a magnetic path M26 in the magnetic pole part 20 is formed wide. Furthermore, since the recessed parts 24 formed in the magnetic pole parts 20 serve as flux barriers, leakage of magnetic flux to the inside in the radial direction is suppressed, and the amount of magnetic flux flowing from the magnets 60 to the stator 80 can be increased. Furthermore, when Id is controlled to 0, a gap (air gap) between the rotor and the magnetic pole part of the stator is narrowed when Id is controlled to 0 and the current amplitude is at its maximum, so that the rotor is attracted more strongly to the stator, and the torque can be improved.

In addition, in the radial direction, the outer end surface 62 of the magnet 60 is located on the inner side of the magnetic body 10 with respect to the outer circumferential surface 22 of the magnetic pole part 20, and therefore a space U is formed between two adjacent magnetic pole parts 20 in the circumferential direction. In this space U, the outer circumferential part 176 or 186 of the cover 170 or 180 is disposed. This space U is a gap G1 formed between two adjacent magnetic pole parts 20 in the circumferential direction. That is, the part of the outer end surface 62 of the magnet 60 that is exposed from the cover 170 or 180 is exposed to the stator 80 in the radial direction and directly opposes the stator 80 illustrated in FIG. 2 without the magnetic body 10 in between. In this configuration, since the gap G1 and the outer circumferential parts 176 and 186 serve as flux barriers, magnetic flux from the outside of the magnet 60 in the radial direction also flows toward the magnetic path M26 of the magnetic pole part 20 of magnetic body 10, as indicated by the arrow in FIG. 5.

In addition, since the magnetic paths M21 and M22 extending from the magnet 60 via the magnetic pole part 20 toward the connection part 40 are also narrowed by the second coupling part 28 and the recessed part 24, magnetic saturation is more likely to occur. Accordingly, leakage of magnetic flux from the magnet 60 via the magnetic pole part 20 and the connection part 40 to the annular part 30 located radially inside is suppressed.

As illustrated in FIG. 5, in the embodiment, the connection part 40 includes a plurality of branched branches (hereinafter referred to as branch parts 41 and 42). The connection part 40 is connected to the annular part 30 via the branch parts 41 and 42 on the inner side in the radial direction. That is, the connection part 40 includes branch parts 41 and 42 which are a plurality of parts branched toward the annular part 30. The branch parts 41 and 42 are connected to the annular part 30.

In this case, a cavity 43 is formed in the part surrounded by the branch parts 41 and 42 of the connection part 40 and the annular part 30. The cavity 43 is disposed radially outward of the second protruding part 31, and the annular part 30 and the cavity 43 are adjacent to each other in the radial direction. That is, a cavity is formed between the branch parts 41 and 42 in the circumferential direction.

Since the cavity 43 also serves as a flux barrier, magnetic paths M41 and M42 passing through the branch parts 41 and 42 extending from the connection part 40 toward the annular part 30 are also narrowed. Even in this configuration, leakage of magnetic flux to the annular part 30 located radially inside is suppressed.

In the embodiment, the second protruding part 31 and the magnetic pole part 20 oppose each other in the radial direction through the cavity 43 and the connection part 40. In this case, the stress applied to the second protruding part 31 in the radial direction when the shaft 90 is press-fitted is reduced by the presence of the cavity 43. That is, when stress is transmitted to the outer circumferential surface 22 of the magnetic pole part 20, the magnetic body 10 is prevented from being deformed and reduction of the roundness is suppressed.

The motor 1 according to the embodiment is required to exhibit high torque at high ambient temperatures, for example, at ambient temperatures of 120 °C to 150 °C. In this case, in addition to demagnetization due to heat, the torque is suppressed by a demagnetizing field due to ampere turns of the coil 83.

It is known that magnets with a high dysprosium (Dy) content can be used to suppress demagnetization, but increasing the proportion of dysprosium in the magnet leads to increased manufacturing costs and a decrease in residual magnetic flux density (Br).

Therefore, in the embodiment, as illustrated in FIG. 4, the magnet 60 is disposed radially inside the rotor 2. For example, the outer diameter D1 of the outer end surface 62 of the magnet 60 is 22.6 mm. According to this configuration, by ensuring a distance between the coil 83 of the stator 80, which is located radially outward, and the outer end surface 62 of the magnet 60, it is possible to reduce the demagnetization rate of the magnet 60 due to heat and ampere turns. For example, it is possible to keep the demagnetization rate at about 2% at the maximum. This allows for a high stall torque. Also, a magnet with a low dysprosium content, such as a magnet with Hcj of 1500 to 1600 KA/m, can be used for the magnet 60.

Furthermore, in a spoke-type IPM, if the magnets are magnetized first, a reaction force will be generated, making assembly difficult. Therefore, it is preferable to magnetize the magnets 60 after the magnets 60 are inserted into the magnetic body 10 (attachment after magnetization).

On the other hand, if the outer end surface 62 of the magnet 60 is too close to the annular part 30 in the radial direction, magnetization may not be possible. Furthermore, if the radial length of the magnet 60 is large, it may be difficult to apply a magnetic field to the entire magnet 60 during magnetization, and thus the radial length of the magnet 60 is required to be short.

Therefore, in the embodiment, the radial length (hereinafter referred to as the magnet length) L1 of the magnet 60 illustrated in FIG. 7 is shortened. For example, by setting the magnet length L1 to the outer diameter D of the rotor 2×3.5/24.5, the magnetization rate can be 90% or more.

Furthermore, in a motor equipped with an IPM rotor, it is known that, when the leakage magnetic flux coefficient is ignored, increasing the surface area of the magnet in contact with the magnetic pole part 20 increases the torque constant. However, when the magnet 60 is extended radially close to the annular part 30, the leakage coefficient increases, and thus there is a problem that the magnet 60 and the torque characteristics are no longer proportional to each other. In particular, when the first protruding part 50 is formed at the magnetic body 10 to support the inner end surface 62 of the magnet 60 from the inside in the radial direction, as in the embodiment, magnetic flux is likely to leak into the annular part 30 via the contact part 56 between the magnet 60 and the first protruding part 50.

In the embodiment, by shortening the radial length (magnet length) L1 of the magnet 60, the magnet 60 is disposed so as not to be too close to the annular part 30 in the radial direction. For example, an inner diameter D2 of the inner end surface 61 of the magnet 60 is equal to or greater than ½ of the outer diameter D0 of the rotor 2, and preferably equal to or greater than ⅔ of the outer diameter D0.

Moreover, the motor 1 according to the embodiment is a small-diameter motor with the rotor 2 having a diameter of, for example, 24.5 mm or less. When the outer diameter (size) of the rotor 2 is small, it may be difficult to form the fine shape of the recessed part 24. For example, it may be difficult to make an inner diameter R of the recessed part 24 equal to or smaller than 0.25 mm.

In the magnetic body 10 according to the embodiment, by forming the recessed part 24, a predetermined size of contact area can be assured between the magnetic pole part 20 and the magnet 60 without extending the magnet 60 radially up to the annular part 30. Furthermore, by making the recessed part 24 larger, the magnetic pole part 20 can be made lighter, and thus the inertia of the rotating body can be reduced.

As described above, the rotor 2 according to the present embodiment includes a magnetic body having two magnetic pole parts 20, an annular part 30, and a protruding part 50 protruding from the annular part 30, and a magnet 60 located between the two magnetic pole parts 20 in the circumferential direction. The magnetic body 10 includes a plurality of magnetic members 100 and 200 stacked in the axial direction. In the radial direction, the magnet 60 is in contact with the protruding part 50. In the rotation axis direction, parts 150 and 250 of the plurality of magnetic members constituting the protruding part 50 are engaged with each other directly or via another member. According to this configuration, since leakage of magnetic flux to the inside in the radial direction via the protruding part 50 can be suppressed, the motor characteristics can be improved.

Furthermore, according to this configuration, since the plurality of magnetic members 100 and 200 can be formed in the same shape, the manufacturability of the rotor 2 can be improved.

### Modified Examples

The configuration according to the embodiment has been described above, but the present invention is not limited to the embodiment. For example, the rotor 2 may be configured such that only one of the parts constituting the protruding parts and the parts of the magnetic pole parts on the connection part side in the plurality of magnetic members illustrated in FIG. 5 are engaged with each other. In each of the following modified examples, the same parts as the parts illustrated in the previously described drawings are denoted by the same signs, and overlapping descriptions are omitted.

Furthermore, the position of the outer end surface 62 of the magnet 60 in the radial direction may be changed depending on, for example, the outer diameter of the rotor 2 and the thickness of the covers 170 and 180.

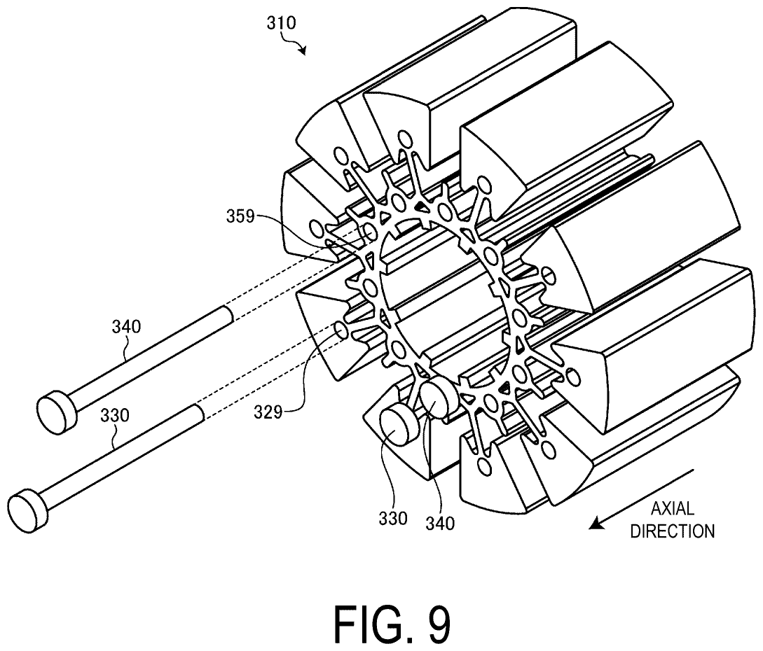

Also, the plurality of magnetic members 100 and 200 may be engaged with each other via other engaging members such as screws 330 and 340 illustrated in FIG. 9. FIG. 9 is a view illustrating an example of insertion of an engaging member into a rotor according to a modified example. The screws 330 and 340 are examples of the other members.

The magnetic body 310 according to the modified example is also formed by stacking a plurality of magnetic members. In the magnetic body 310 according to the modified example, a through hole 329 is formed in the magnetic pole part 20 and a through hole 359 is formed in the connection part 40. The screw 330 is inserted into the through hole 329, and the screw 340 is inserted into the through hole 359. The screws 330 and 340 illustrated in FIG. 9 are made of a material having a lower magnetic permeability than a magnetic permeability of an electromagnetic steel sheet, such as stainless steel including SUS, for example. That is, the plurality of magnetic members according to the modified example are engaged with each other via the other members including the screws 330 and 340.

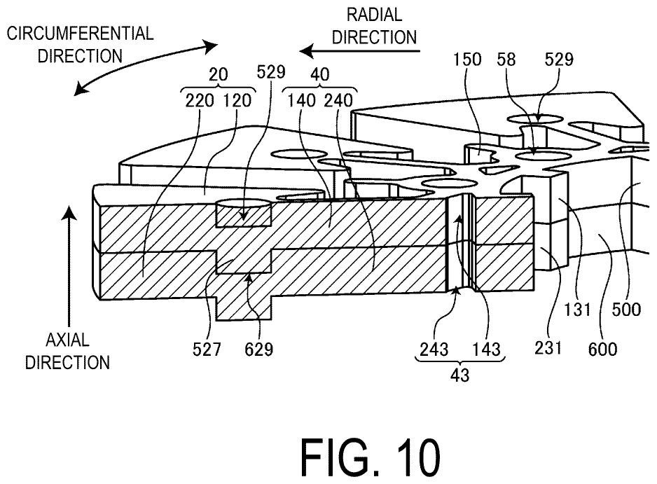

In addition, instead of using screws, as illustrated in FIG. 10, one magnetic member 500 of two overlapping magnetic members 500 and 600 among the plurality of stacked magnetic members may have an engaging part 527 such as a dowel formed at the surface opposing the other magnetic member 600 side, and the other magnetic member 600 may have an engaged part 629 such as a recessed part formed at the surface opposing the one magnetic member 500 side. FIG. 10 is an enlarged cross-sectional view illustrating an example of a magnetic member according to another modified example. Furthermore, the other magnetic member 600 may be formed with a through hole or the like as an engaged part instead of the recessed part. The engaging part 527 and the engaged part 629 are engaged with each other, and the two overlapping magnetic members 500 and 600 are engaged with each other. As in the embodiment, the two magnetic members 500 and 600 may have the same shape. In this case, as illustrated in FIG. 10, one magnetic member 500 has a recessed part 529 formed on the surface opposite to the other magnetic member 600.

The 330 and 340 such as screws or the like may be inserted from the negative side in the axial direction. Also, the engaging member may be configured to be inserted into only one of the through holes 329 and 359.

Furthermore, the material of the covers 170 and 180 may be any non-magnetic or low-magnetic member, and is not limited to the material described in the embodiment. Furthermore, the method for fixing the covers 170 and 180 to the magnetic body 10 may be other methods such as shrink fitting, cold fitting, or the like.

Although the present invention has been described above on the basis of the embodiments and each modified example, the present invention is not limited to the embodiments and each modified example, and it goes without saying that various variations can be made without departing from the gist of the present invention. Various variations without departing from such gist are also included in the technical scope of the present invention, and this is apparent to those skilled in the art from the description of the claims.

### REFERENCE SIGNS LIST

1 Motor, 2 Rotor, 10, 310 Magnetic body, 20 Magnetic pole part, 28 Second coupling part, 329 Through hole, 30 Annular part, 31 Second protruding part, 40 Connection part, 41, 42 Branch part, 43 Cavity, 50 First protruding part, 58 First coupling part, 359 Through hole, 60 Magnet, 61 Inner end surface, 62 Outer end surface, 63, 64 Side surface, 80 Stator, 90 Shaft, 100, 200 Magnetic member, 127 Second engaging part, 157 First engaging part, 170, 180 Cover, 330, 340 Screw, 900 Electronic device, 910 Worm, 920 Output gear, 930 Output shaft, 940 Housing

1. A rotor comprising:
a magnetic body including two magnetic pole parts, an annular part, and a protruding part protruding from the annular part; and
a magnet located between the two magnetic pole parts in a circumferential direction, wherein the magnetic body includes a plurality of magnetic members stacked in an axial direction,
in a radial direction, the magnet is in contact with the protruding part, and
in a rotation axis direction, parts of the plurality of magnetic members forming the protruding part are engaged with each other directly or via another member.

2. The rotor according to claim 1, wherein each of the parts of the plurality of magnetic members forming the protruding part includes a first engaging part.

3. The rotor according to claim 2, wherein the first engaging parts stacked in the rotation axis direction form a flux barrier in the magnetic body.

4. The rotor according to claim 2, wherein
the magnetic body includes a connection part connecting the magnetic pole part and the annular part, and
a part of the magnetic member forming the connection part is connected to the first engaging part of the magnetic member.

5. The rotor according to claim 4, wherein
the connection part includes a plurality of parts branched toward the annular part,
the plurality of branched parts are connected to the annular part, and
a cavity is formed between the plurality of branched parts in the circumferential direction.

6. The rotor according to claim wherein a part of the plurality of magnetic members forming the magnetic pole part is engaged with a part of the magnetic pole part on the connection part side in the rotation axis direction, directly or via another member.

7. The rotor according to claim 6, wherein
a part of the magnetic member forming the magnetic pole part includes a second engaging part, and
the second engaging part is located on the connection part side.

8. The rotor according to claim 7, wherein the second engaging parts stacked in the rotation axis direction form a flux barrier in the magnetic body.

9. A motor comprising:
the rotor according to claim 1;
a shaft; and
a stator.

10. An electronic device comprising:
the motor according to claim 9; and
a housing that accommodates the motor.

11. An electronic device comprising:
the motor according to claim 9; and
one or a plurality of gears.
